(19) United States
(12) Patent Application Publication
(10) Pub. No.: US 2012/0233019 A1
(43) Pub. Date: Sep. 13, 2012

(54) METHOD AND APPARATUS FOR MANAGING CONTENT TO BE SHARED AMONG DEVICES

(75) Inventors: Yong-ho HWANG, Seoul (KR); Choong-hoon LEE, Seoul (KR); Sang-su CHOI, Hwaseong-si (KR); Jin-mok KIM, Yongin-si (KR)

(73) Assignee: SAMSUNG ELECTRONICS CO., LTD., Suwon-si (KR)

(21) Appl. No.: 13/349,214

(22) Filed: Jan. 12, 2012

(30) Foreign Application Priority Data
Mar. 8, 2011 (KR) 10-2011-0020622

(51) Int. Cl. G06F 21/24; G06F 15/16; G06Q 30/00

(52) U.S. Cl. 705/26.41; 726/28

(57) ABSTRACT

A method and apparatus for managing content among user devices is provided. The method includes requesting, from a first server, a list of Digital Rights Management (DRM) supported by at least one user device upon receiving a request to download content; using the list of DRM received from the first server to assign at least one second server supported by the at least one user device; and communicating with the assigned at least one second server to download, to the end user device, the content with at least one DRM license supported by the at least one user device.

### CROSS-REFERENCE TO RELATED PATENT APPLICATION

This application claims priority from Korean Patent Application No. 10-2011-0020622, filed on Mar. 8, 2011, in the Korean Intellectual Property Office, the disclosure of which is incorporated by reference herein in its entirety.

### BACKGROUND

1. Field

Methods and apparatuses consistent with the present disclosure relate to a content management system, and more particularly, to a method and apparatus for managing content to be shared among devices.

2. Description of the Related Art

Digital Rights Management (DRM) refers to a technology and service for protecting a provider's copyrights and interests by disabling illegal distribution of digital content. Recent digital content tends to be circulated in a DRM-protected format. In this case, a user needs to remove the DRM protection from the received content for use.

On the other hand, a Digital Entertainment Content Ecosystem (DECE) aims at free circulation of content according to a common digital standard. According to such a DECE standard, there is only a description in a DRM box of uniform resource locater (URL) information for receiving the DRM, so when executing content in a device that needs new DRM, a user of the device has to fetch corresponding DRM from a server. Therefore, there is a disadvantage in that the device in need of new DRM for executing content must always be online to download the corresponding DRM from the server.

### SUMMARY

The present disclosure provides a method and an apparatus for managing content to be shared among devices that support different Digital Rights Management (DRM).

According to an aspect of an exemplary embodiment, there is provided a method of managing content among user devices, the method comprising requesting, from a first server, a list of Digital Rights Management (DRM) supported by at least one user device upon receiving a request to download content; using the list of DRM received from the first server to assign at least one second server supported by the at least one user device; and communicating with the assigned at least one second server to download, to the end user device, the content with at least one DRM license supported by the at least one user device.

The first server may be a domain manager server for registering user devices and creating the list of DRM supported by the registered user devices.

The end user device may be one of the registered user devices.

The at least one second server may be at least one download service server that stores DRM information supported by the registered user devices and downloads content according to a request.

The first server may create the list of DRM supported by at least one user device by using the registered user devices when requested for the list of DRM.

The downloading of the content may comprise requesting and receiving at least one DRM license from the assigned at least one second server; and requesting to download content from a second server selected from the assigned at least one second server, and forwarding the at least one DRM license to the selected second server, wherein the selected second server uses the at least one DRM license to create a content header and provides the content with the content header to the end user device.

The requesting and receiving of at least one DRM license from the assigned at least one second server may be performed in sequence or in parallel.

The downloading of the content may comprise requesting to create the at least one DRM license from the assigned at least one second server and forwarding the created at least one DRM license to a selected second server, wherein the selected second server collects the created at least one DRM license to create a content header and provides the content with the content header for the end user device.

The at least one DRM license supported by the at least one user device may be added to DRM information of the content header.

According to another aspect of an exemplary embodiment, there is provided a method of managing content among user devices that support different Digital Rights Management (DRM), the method comprising requesting, from a first server, a list of DRM supported by at least one user device upon receiving a request for DRM information; using the list of DRM received from the first server to assign at least one second server supported by the at least one user device; and communicating with the assigned at least one second server to download the DRM information that includes at least one DRM license to the end user device.

Upon receiving the request for the list of DRM, the first server may use registered user devices to create the list of DRM supported by the at least one user device.

The communicating with the at least one second server to download the DRM information that includes at least one DRM license to the end user device may comprise requesting to download to the end user device corresponding DRM licenses from the at least one second server.

The communicating with the at least one second server to download the DRM information that includes at least one DRM license to the end user device may comprise requesting at least one DRM license from the assigned at least one second server, forwarding the at least one DRM license to a selected one of the at least one second server, and requesting from the selected one of the at least one second server to download to the end user device the at least one DRM license, wherein the selected one of the at least one second server collects the at least one DRM license and downloads DRM information including the collected at least one DRM license to the end user device.

The communicating with the at least one second server to download the DRM information that includes at least one DRM license to the end user device may comprise requesting to create at least one DRM license from the assigned at least one second server, and to collect and download the created at least one DRM license to the end user device from a selected one of the at least one second server, wherein the selected one of the at least one second server collects the at least one DRM license and downloads the DRM information including the collected at least one DRM license to the end user device.

The method may further comprise the end user device matching the DRM information with previously stored content.

The method may further comprise the end user device adding information of at least one DRM license supported by the at least one user device in a header field of previously stored content.

According to another aspect of an exemplary embodiment, there is provided an apparatus for managing content, the apparatus comprising a content purchase handling unit that requests a list of Digital Rights Management (DRM) supported by at least one user device from a domain manager server upon receiving, from an end user device, a request to download content or DRM information; a server assigning unit that analyzes the list of DRM received from the domain manager server and assigns at least one download service server supported by the at least one user device, upon receiving the request for the list of DRM from the content purchase handling unit; and a DRM information processing unit that communicates with the assigned at least one download service server to download, to the end user device, the at least one DRM license or content including at least one DRM license.

The DRM information processing unit may request and receive at least one DRM license from the assigned at least one download service server in sequence or in parallel.

According to another aspect of an exemplary embodiment, there is provided a system for managing content comprising a domain manager server that registers at least one user device and creates a list of Digital Rights Management (DRM) supported by at least one registered user device, in response to a request for the list; and a content service server that requests and receives, from the domain manager server, the list of DRM supported by the at least one registered device, uses the received list of DRM to assign at least one download service server supported by the at least one registered user device, and communicates with the assigned at least one download service server to download, to the end user device, content including at least one DRM license supported by at least one user device, wherein the at least one download service server stores at least one DRM license supported by the registered at least one user device and provides content with the at least one DRM license for the end user device when requested by the content service server.

The download service server may comprise a DRM information creating unit that creates the at least one DRM license, or collects DRM licenses from other download service servers to create a content header when requested to download content with DRM by the content service server, and a DRM information providing unit that provides to the end user device the at least one DRM license or the content header created by the DRM information creating unit.

The download service server may comprise a DRM license server for providing information of DRM licenses supported by the at least one registered user device.

According to another aspect of an exemplary embodiment, there is provided a computer-readable storage medium having a program embodied thereon for carrying out the method.

### BRIEF DESCRIPTION OF THE DRAWINGS

The above and other aspects will become more apparent by describing in detail exemplary embodiments thereof with reference to the attached drawings in which:

FIG. 1 is a schematic content management system according to an exemplary embodiment;

FIG. 2 is a schematic block diagram of a content service server of FIG. 1 according to an exemplary embodiment;

FIG. 3 is a schematic block diagram of a download service server of FIG. 1 according to an exemplary embodiment;

FIG. 4 shows a content format to which a DRM license supported by a user device can be added according to an exemplary embodiment;

FIG. 5 is a flowchart of a method of managing content in the content service server, according to an exemplary embodiment;

FIG. 6 is a flowchart of a method of managing content in the content service server, according to another exemplary embodiment;

FIG. 7 shows a network system to explain the method of managing content of FIG. 5;

FIG. 8 is a flowchart of the method of managing content of FIG. 6;

FIG. 9 shows an example of choosing player devices in a domain manager server;

FIG. 10 shows a network system to explain the method of managing content of FIG. 6;

FIG. 11 is a flowchart of the method of managing content of FIG. 6;

FIG. 12 shows a network system to explain a method of managing content of FIG. 13;

FIG. 13 is a flowchart of the method of managing content according to another exemplary embodiment;

FIG. 14 is a flowchart of a method of managing content according to another exemplary embodiment; and

FIG. 15 is a flowchart of a method of managing content according to another exemplary embodiment.

### DETAILED DESCRIPTION

Exemplary embodiments will now be described with reference to accompanying drawings.

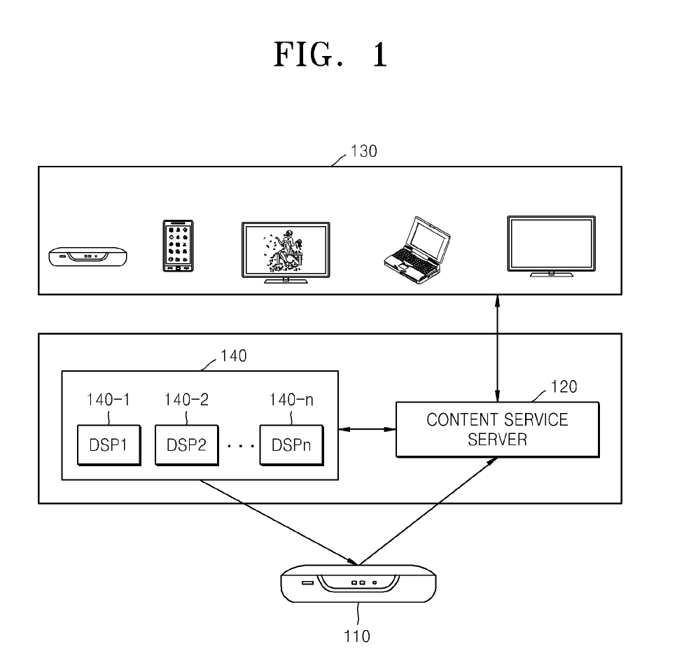

FIG. 1 is a schematic content management system according to an exemplary embodiment.

Referring to FIG. 1, the content management system may include an end user device 110, a content service server 120, a domain manager server 130, and a download service server 140. The download service server 140 may comprise first to nth download service servers 140-1 to 140-n.

The domain manager server 130 registers various user devices and stores DRM information for each of the registered user devices. For example, as shown in FIG. 1, the user has, for example, an end user device, a smartphone, a television (TV), a game console, and a second TV or computer system, etc., and has acquired rights to various content on each device. Each device may support a different DRM. For example, a cellular phone may support a first DRM such as Open Conditional Content Access Management (OCCAM), and a smart phone may support a second DRM such as Digital Transmission Content Protection (DTCP). Content is served up by the various download service servers 140-1 to 140-n.

The end user device 110 in FIG. 1 is a user device registered by the domain manager server 130. For example, the end user device 110 may be a user's cellular phone registered via a web portal of the domain manager server 130. The domain manager server 130 generates a list of DRM of the user devices using the DRM for the user devices according to a request of the content service server 120, as will be described in more detail below.

The end user device 110 may request to buy and download content from the content service server 120, and may download the content including corresponding DRM information from at least one of the first to nth download service servers 140-1 to 140-n.

The content service server 120 decides which of the download service servers 140 supported by the registered user devices using the list of DRM. The list of DRM includes the DRM for the registered user devices. For example, the list of DRM may include the first DRM supported by a cellular phone, the second DRM supported by a smart phone, and the third DRM supported by a TV set.

The download service servers 140-1 through 140-n include the DRM information (e.g., a DRM license) used by the registered user devices. For example, the first download service server 140-1 includes the DRM information used by a first user device (e.g., a cellular phone), and the second download server 140-2 includes the DRM information supported by a second user device (e.g., a TV set), etc.

Thus, the content service server 120 decides the download service servers 140 using the list of DRM of the registered user devices. For example, the content service server 120 decides the first download service server 140-1 including the DRM information used by a first user device (e.g. a cellular phone), and the second download service server 140-2 including the DRM information used by a second user device (e.g., a TV set).

For example, the content service server 120 may be a front-end store, such as Blockbuster or Netflix, which sells content to the end user device 110. In such a case, the content may be provided by various other parties, and provided with associated DRM. The content service server 120 may be associated with at least one download service server for supporting various DRM. When requested, by the end user device 110, to download content or DRM information, the content service server 120 may, in turn, request a list of DRM supported by one or more of the registered user devices that have been registered by the user with the domain manager server 130, from the domain manager server 130, use the list of DRM to assign at least one of the first to nth download service servers 140-1 to 140-n supported by the one or more registered user devices, and communicate with the assigned at least one first to nth download service server 140-1 to 140-n to download content with at least one DRM license supported by at least one registered user device to the end user device 110. For example, if a user of the end user device 110 would like to play a movie, the rights to which the user previously acquired using the TV and registered with the domain manager server 130, the content service server 120 would requests a list of DRM information from the TV, would use the list to assign an appropriate download service server 140 that handles the movie, and communicate with the assigned download service server 140 to download the movie with an associated DRM license to the end user device for playback.

The domain manager server 130 may register users, users' purchase history, and user devices, and serve to have other content service servers in the same domain re-download the content purchased from the content service server 120. The domain manager server 130 may also create a list of DRM supported by at least one registered device at the request of the content service server 120.

The download service server 140 stores DRM licenses for the registered user devices and encrypted content. The download service server 140 may transmit the content purchased from the content service server 120 to the end user device 110. The download server 140 may also operate a DRM license server to provide DRM licenses for corresponding content.

The download service server 140 may comprise first to nth download service servers 140-1 to 140-n for providing at least a piece of DRM information to the end user device 110.

The download service server 140 may have DRM licenses supported by registered user devices, and provide the end user device 110 with content that includes DRM licenses at the request of the content service server 120.

Consequently, a user may download at least one DRM license from the download service server 140 by using the DRM information of the at least one user device previously registered at the domain manager server 130.

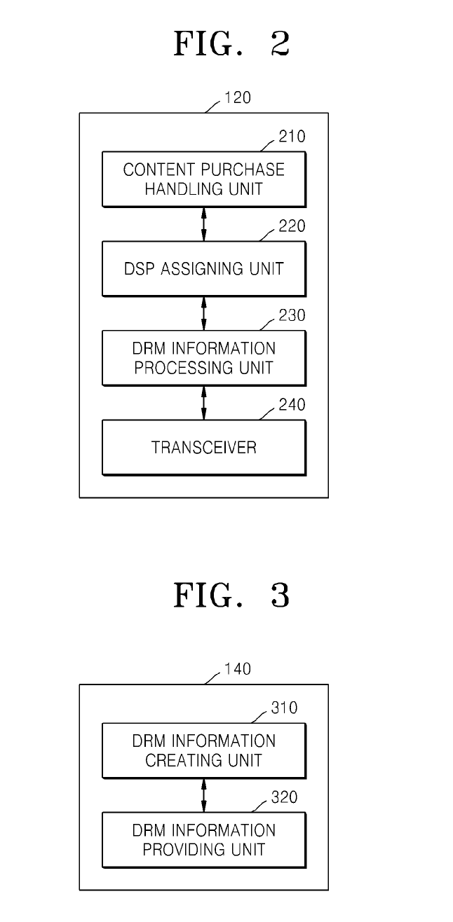

FIG. 2 is a schematic block diagram of the content service server 120 of FIG. 1, according to an exemplary embodiment.

The content service server 120 may include a content purchase handling unit 210, a digital signal processor (DSP) assigning unit 220, a DRM information processing unit 230, and a transceiver 240.

The content purchase handling unit 210 may request the list of DRM supported by at least one registered user device from the domain manager server 130 when requested to download content or DRM information by the end user device 110.

The DSP assigning unit 220 may analyze the list of DRM that is received from the domain manager server 130 at the request of the content purchase handling unit 210, and then assign at least one of the first to nth download service servers 140-1 to 140-n using the list of DRM.

The DRM information processing unit 230 may communicate with the at least one first to nth download service servers 140-1 to 140-n assigned by the DSP assigning server 220 to facilitate the downloading of content with at least one DRM license, or only the at least one DRM license to the end user device 110.

The transceiver 240 may communicate with the end user device 110, the domain manager server 130, and the at least one first to nth download service server 140-1 to 140-n to exchange contents or DRM information.

FIG. 3 is a schematic block diagram of the download service server 140 of FIG. 1 according to an exemplary embodiment.

The download service server 140 may include a DRM information creating unit 310 and a DRM information providing unit 320.

The DRM information creating unit 310 may create at least one DRM license, or create a content header by collecting DRM licenses from other download service servers, at the request of the content service server 120 for DRM and content.

The DRM information providing unit 320 may provide the at least one DRM license or the content header created by the DRM information creating unit 310 for the end user device 110.

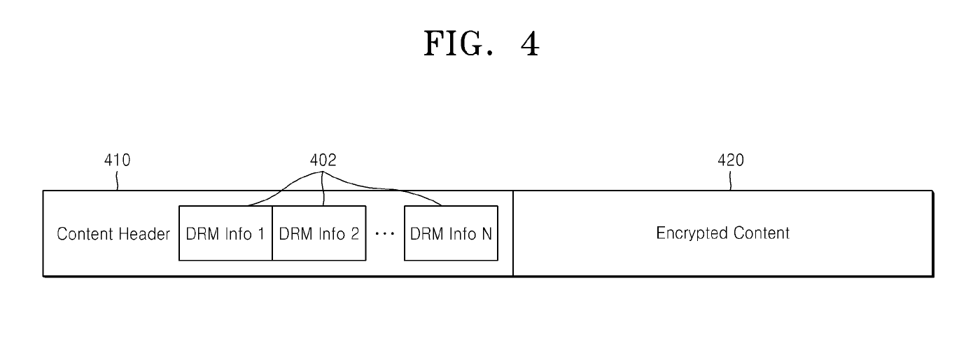

FIG. 4 shows a content format to which at least one DRM license supported by at least one registered user device can be added according to an exemplary embodiment.

The content format shown in FIG. 4 may be divided into a content header field 410 and an encrypted content field 420. The content header field 402 may further include N DRM information fields 402. The N DRM information fields 402 may contain at least one DRM license supported by the at least one user device.

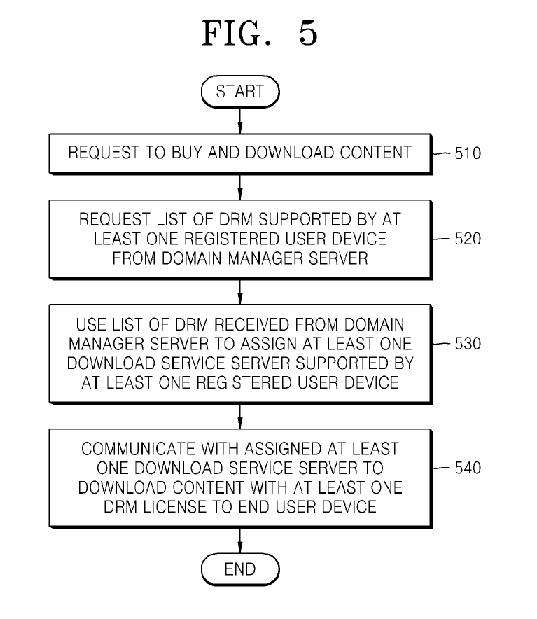

FIG. 5 is a flowchart of a method of managing content in the content service server 120, according to an exemplary embodiment.

First, the content service server 120 may be requested by the end user device 110 to sell content to the end user device 110 and transmit the content that is sold to the end user device 110 in operation 510. That is, the end user device 110 may send a request to buy and download content from the content service server 120. The content service server 120 may then request a list of DRM supported by at least one registered user device from the domain manager server 130 in operation 520. Then, the content service server 120 may use the list of DRM to assign at least one download service server in operation 530. Next, the content service server 120 may communicate with the assigned at least one download service server to download to the end user device 110 content with at least one DRM license in operation 540.

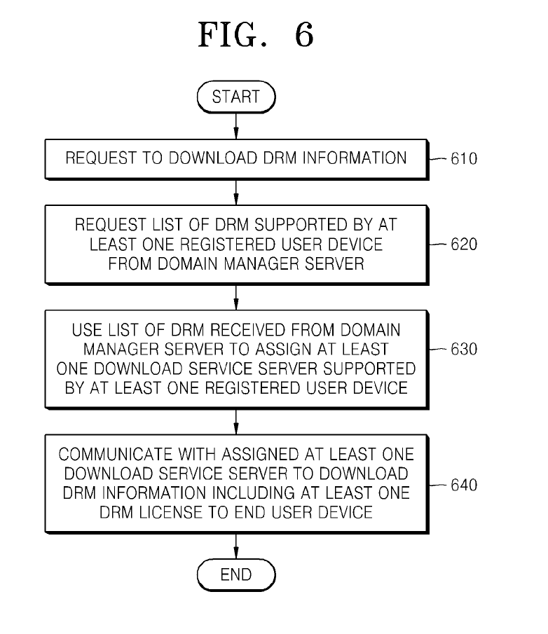

FIG. 6 is a flowchart of a method of managing content in the content service server 120, according to another exemplary embodiment.

First, the content service server 120 may be requested, by the end user device 110, to download DRM information that includes a DRM header and at least one DRM license to the end user device 110 in operation 610. That is, the content service server 120 receives a request from the end user device 110 to download DRM information, where the DRM information includes a DRM header and at least one DRM license. The content service server 120 may in turn request a list of DRM from the domain manager server 130 in operation 620. Then, in operation 630, the content service server 120 may assign at least one download service server by using the list of DRM received from the domain manager server 130. Next, the content service server 120 may communicate with the assigned at least one download service server to download DRM information to the end user device 110, the DRM information including at least one DRM license in operation 640.

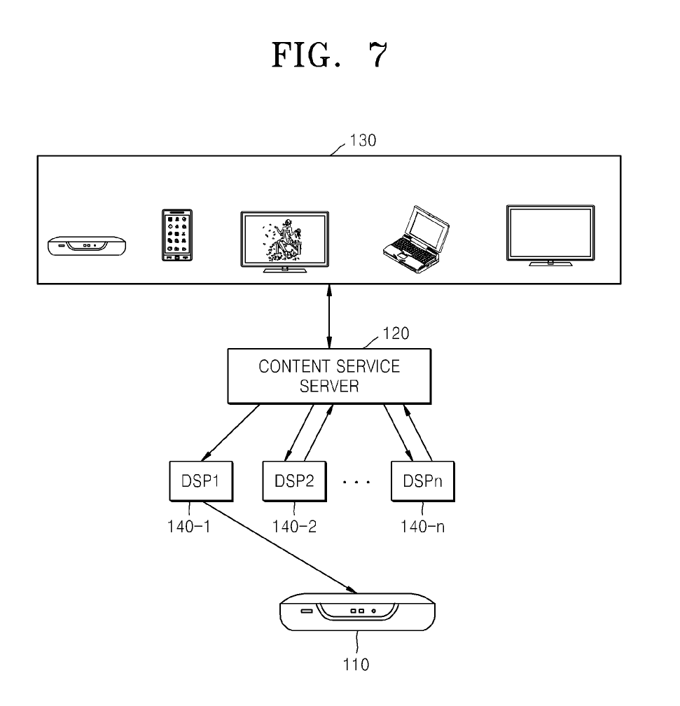

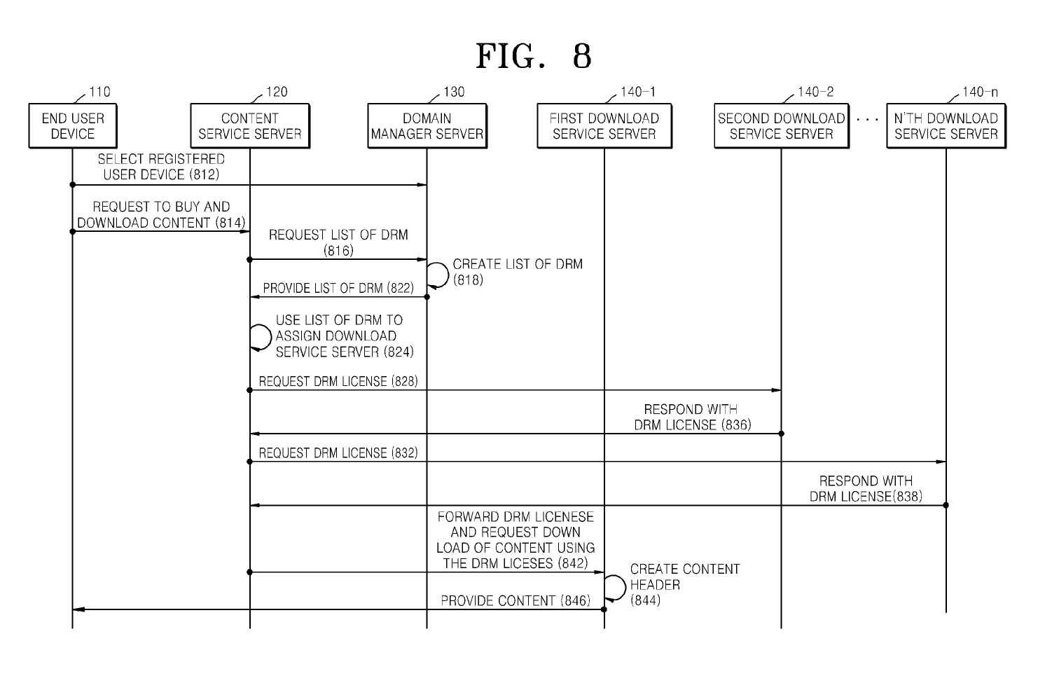

FIG. 8 is a flowchart of the method of managing content of FIG. 5. The method will be described in conjunction with a network system as shown in FIG. 7.

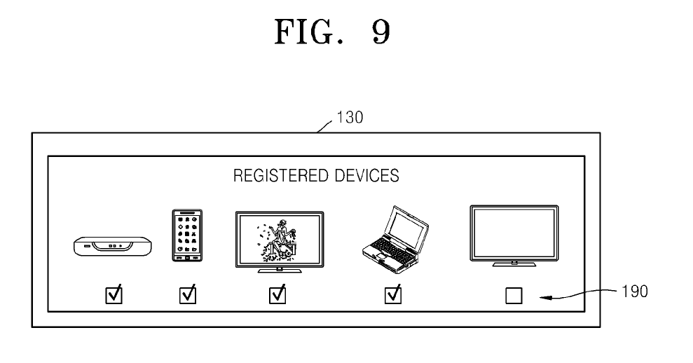

First, the end user device 110 may send the domain manager server 130 a command to select at least one registered user device in operation 812. For example, a user can select at least one registered user device among user devices registered at a web portal provided by the domain manager server 130, which may operate, as in operation 910 shown in FIG. 9. If the user decides to purchase content, the end user device 110 may request to buy and download the content from the content service server 120 in operation 814. The content service server 120 may in turn request a list of DRM from the domain manager server 130 in operation 816. Then, the domain manager server 130 may create the list of DRM associated with at least one registered user device in operation 818. The domain manager server 130 may then provide the created list of DRM to the content service server 120 in operation 822. And then, the content service server 120 may assign at least one download service server by using the list of DRM in operation 824. For example, the content service server 120 can assign the second and n^{th} download service servers 140-2 and 140-n. The content service server 120 may then request DRM licenses from the second and n^{th} download service servers 140-2 and 140-n in sequence or in parallel in operations 828 and 832, respectively. The second and n^{th} download service servers 140-2 and 140-n may respond by providing respective DRM licenses to the content service server 120 in operations 836 and 838, respectively. Next, the content service server 120 may request to download content from a first download service server 140-1, and forward the received DRM licenses from the second and n^{th} download service servers 140-2 and 140-n to the first download service server 140-1 in operation 842. The first download service server 140-1 may then use the received at least one DRM license to create a content header to which corresponding DRM licenses are added in operation 844, and provide content with the content header for the end user device 110 in operation 846. The DRM licenses may be added in a DRM information field 402 in the contents header. The end user device 110 may reproduce the content downloaded from the first download service server 140-1.

As such, the user can reproduce content not only online but also offline when reproducing the content of any of his/her registered devices, because the user can use the multiple DRM information included in the content without a need to obtain new DRM licenses from a server. Accordingly, free sharing of content can be realized among user devices which support different DRM.

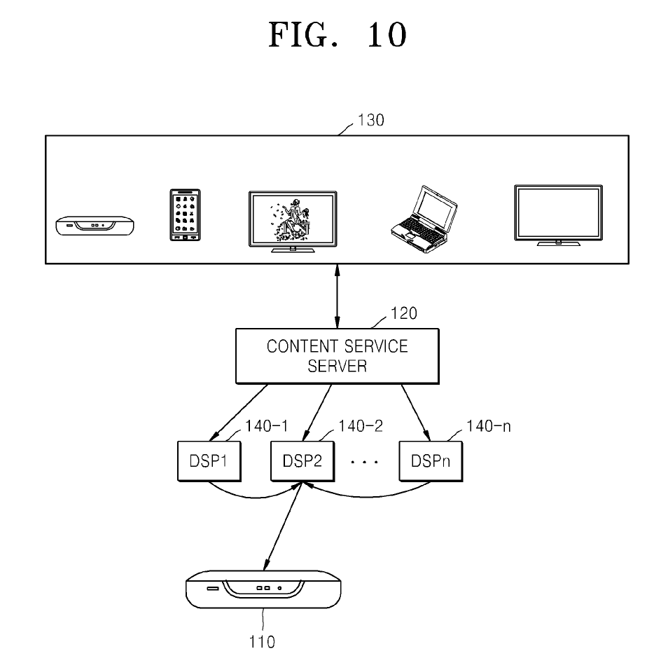

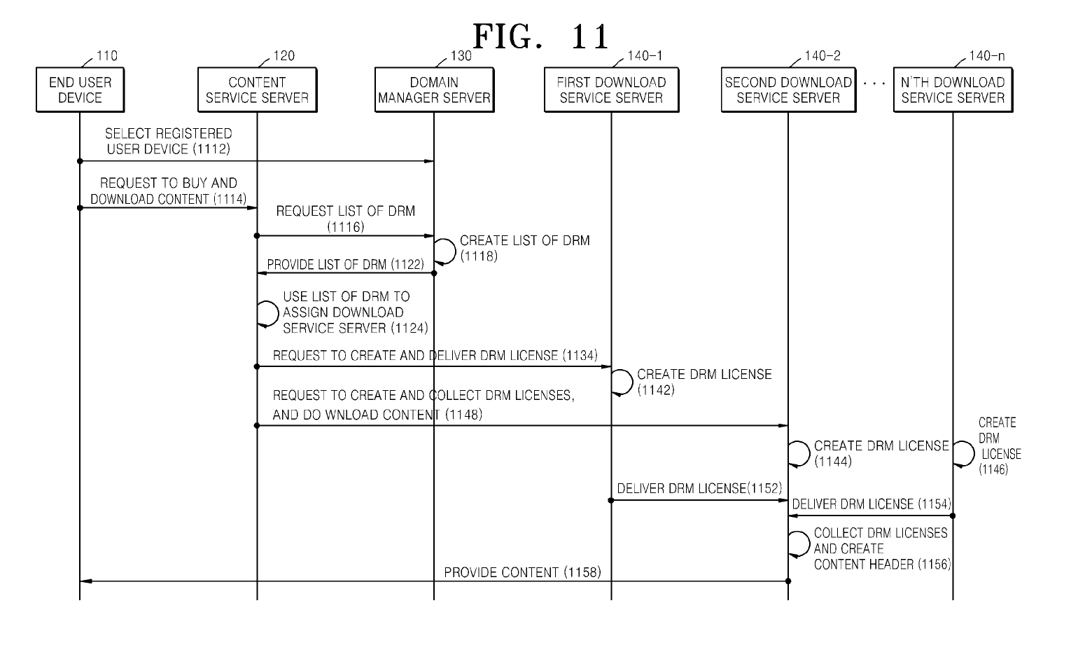

FIG. 11 is a flowchart of the method of managing contents of FIG. 6. The method will be described in conjunction with a network system shown in FIG. 10.

First, the end user device 110 may send the domain manager server 130 a command to select at least one user device in operation 1112. If the user decides to purchase content, the end user device 110 may request to buy and download content from the content service server 120 in operation 1114. The content service server 120 may in turn request a list of DRM in operation 1116. The domain manager server 130 may create the list of DRM in operation 1118. Then, the domain manager server 130 may provide the created list of DRM to the content service server 120 in operation 1122. The content service server 120 may assign at least one download service server by using the list of DRM, in operation 1124. For example, the content service server 120 can assign the first and n^{th} download service servers 140-1 and 140-n. The content service server 120 may request to create and deliver DRM licenses from the first and n^{th} download service servers 140-1 and 140-n in sequence or in parallel in operations 1134 and 1136, respectively. The first and n^{th} download service servers 140-1 and 140-n may create respective DRM licenses in operation 1142 and 1146, respectively. The content service server 120 may also request to create, collect, and download DRM licenses from the selected second download server 140-2 in operation 1148. The second download service server 140-2 may also create the DRM license in operation 1144. The first and n^{th} download service servers 140-1 and 140-n may forward their respective created DRM licenses to the second download service server 140-2, respectively, in operations 1152 and 1154. The second download service server 140-2 may collect the DRM licenses received from the first and n^{th} download service servers 140-1 and 140-n, and create a content header in operation 1156. The DRM licenses are added in the DRM information field 402 in the content header. The second download service server 140-2 provides content with the content header for the end user device 110, in operation 1158. The end user device 110 may reproduce the content downloaded from the first download service server 140-1.

As such, the user can reproduce content not only online but also offline when reproducing the content on any of his/her registered devices, because the user can use the pieces of DRM information included in the content without a need to obtain new DRM licenses from a server. Accordingly, free sharing of content can be realized among user devices that support different DRM.

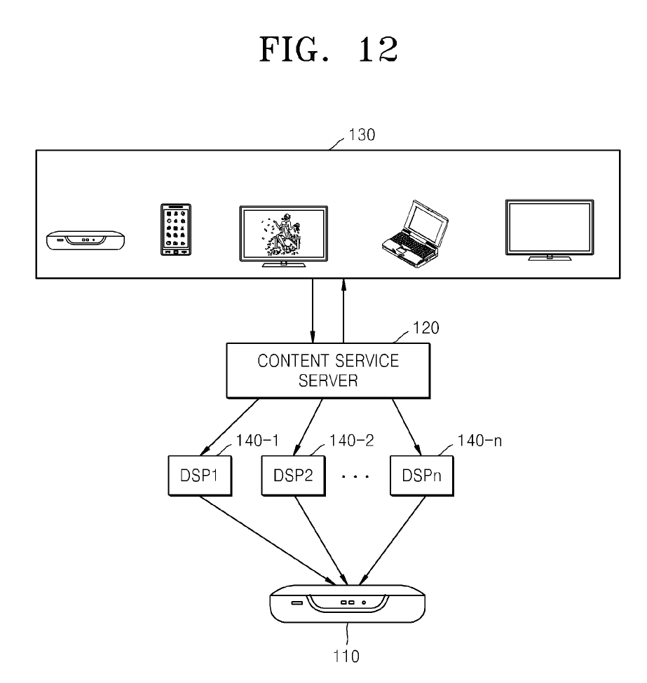

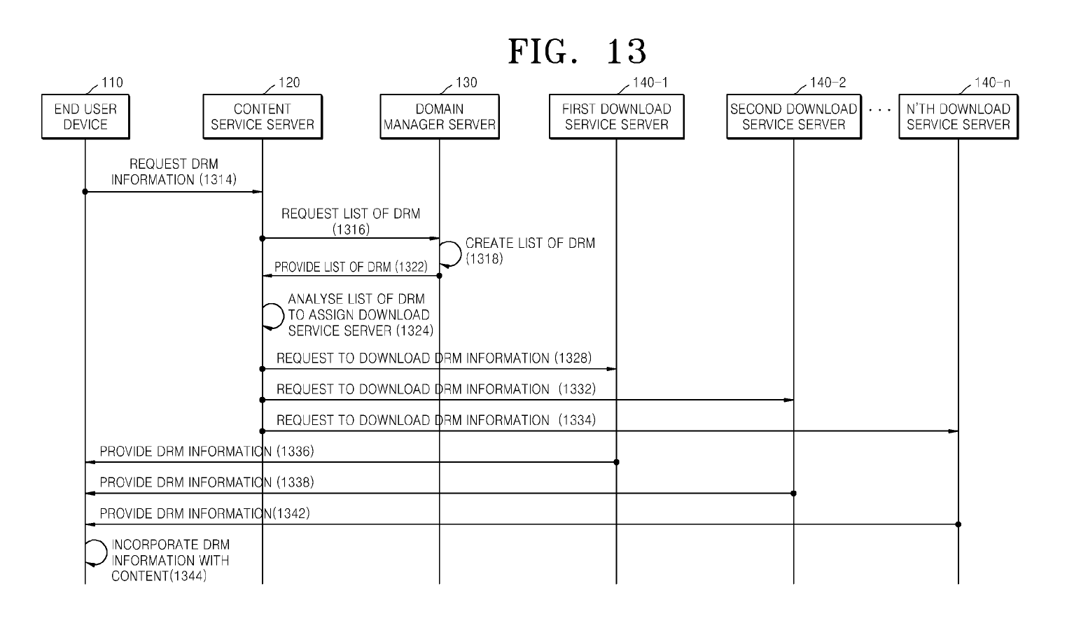

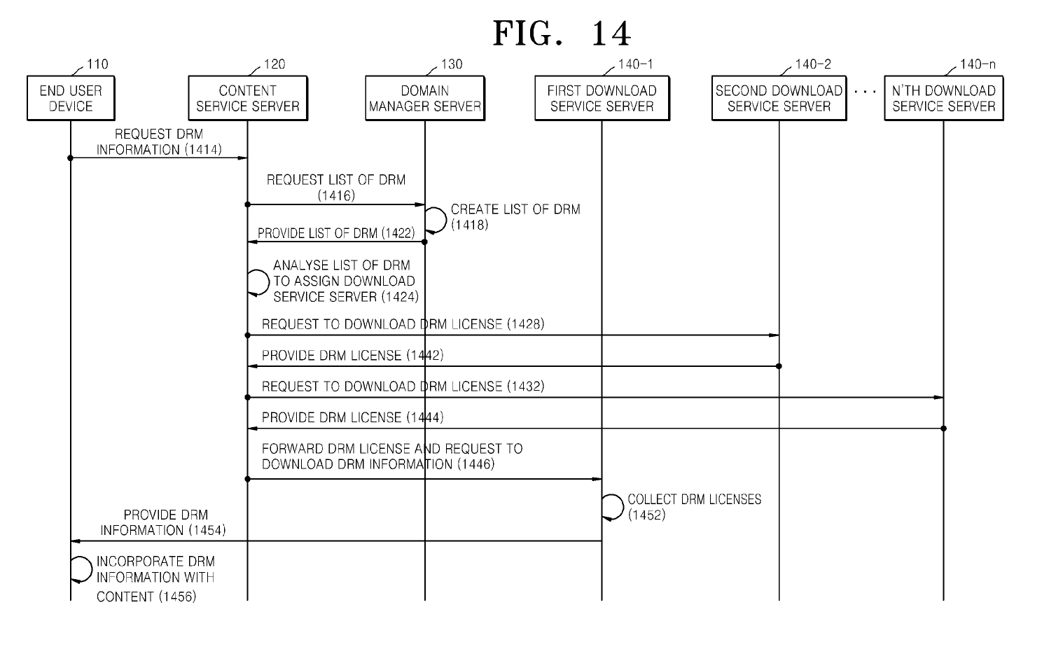

FIG. 13 is a flowchart of a method of managing contents according to another exemplary embodiment. The method will be described in conjunction with a network system as shown in FIG. 12.

The end user device 110 may store content. If the user wants DRM information related to the content, the end user device 110 may request the DRM information from the content service server in operation 1314. The DRM information may include a DRM header and at least one DRM license. The content service server 120 may request from the domain manager server 130 a list of DRM in operation 1316. The domain manager server 130 may create the list of DRM in operation 1318. The domain manager server 130 may then provide the created list of DRM to the content service server 120 in operation 1322. The content service server 120 may analyze the list of DRM and assign at least one download service server by using the list of DRM in operation 1324. For example, the content service server 120 may assign first, second, and nth download service servers 140-1, 140-2, and 140-n. The content service server 120 may request to download DRM information from the first, second, and nth download service servers 140-1, 140-2, and 140-n in sequence or in parallel in operations 1328, 1332, and 1334. The first, second and nth download service servers 140-1, 140-2, and 140-n may provide respective DRM information in operations 1336, 1338, and 1342, respectively. The DRM information may include a DRM header and at least one DRM license. The end user device 110 may match the DRM information received from the first, second and nth download service servers 140-1, 140-2, and 140-n with content in operation 1344. To do so, the end user device 110 has a function of header addition, such as a header packer. Accordingly, the end user device 110 may add at least one piece of the DRM information in a header field of the stored content.

As such, the user can reproduce his/her own content not only online but also offline when reproducing the content on any of his/her registered devices by matching the received pieces of DRM information with the content without a need to obtain new DRM licenses from a server. Accordingly, free sharing of content can be realized among user devices that support different DRM.

FIG. 14 is a flowchart of a method of managing content according to another exemplary embodiment.

The end user device 110 may store content. If the user wants DRM information related to the content, the end user device 110 may request the DRM information from the content service server in operation 1414. The DRM information may include a DRM header and at least one DRM license. The content service server 120 may request from the domain manager server a list of DRM in operation 1416. The domain manager server 130 may create the list of DRM in operation 1418. The domain manager server 130 may then provide the created list of DRM to the content service server 120 in operation 1422. The content service server 120 may analyze the list of DRM and assign at least one download service server by using the list of DRM in operation 1424. For example, the content service server 120 may assign the first, second and nth download service servers 140-1, 140-2, and 140-n. The content service server 120 may request to download respective DRM licenses from the second and n^{th} download service servers 140-2 and 140-n in sequence or in parallel in operations 1428 and 1432, respectively. The second and n^{th} download service servers 140-2 and 140-n may provide respective DRM licenses in operations 1442 and 1444, respectively. The content server 120 may forward the DRM licenses received from the second and n^{th} download service servers 140-2 and 140-n to the first download server 140-1, and request to download DRM information from the first download server 140-1 in operation 1446. The first download server 140-1 may collect the multiple DRM licenses received from the content service server 120 in operation 1452. The first download server 140-1 may then provide DRM information having the collected DRM licenses to the end user device 110 in operation 1454. Then, the end user device 110 may match the DRM information received from the first download service server 140-1 with its content in operation 1456. To do so, the end user device 110 has a function of header addition, according to which the end user device 110 is able to add at least one piece of the DRM information in a header field of the stored content.

As such, the user can reproduce his/her own content not only online but also offline when reproducing the content on any of his/her registered devices by matching the received DRM information with the content without a need to obtain a new DRM license from a server. Accordingly, free sharing of content can be realized among user devices that support different DRM.

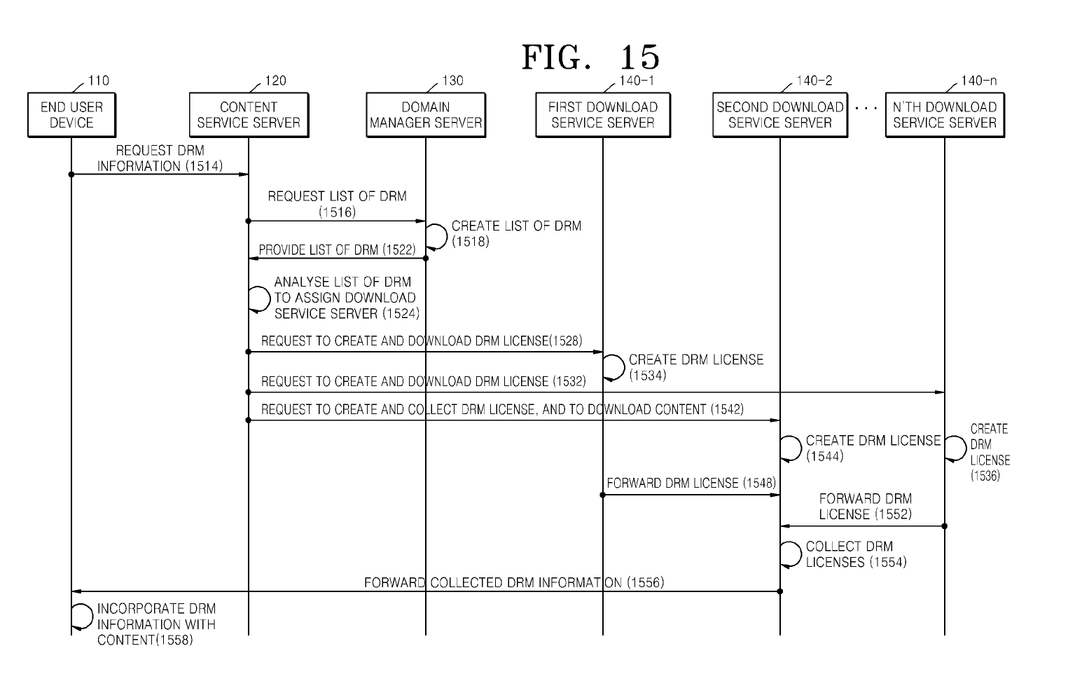

FIG. 15 is a flowchart of a method of managing content according to another exemplary embodiment.

The end user device 110 may store content. If the user wants DRM information related to the content, the end user device 110 may request the DRM information from the content service server in operation 1514. The DRM information may include a DRM header and at least one DRM license. The content service server 120 may request from the domain manager server a list of DRM in operation 1516. The domain manager server 130 may create the list of DRM by using registered user devices in operation 1518. The domain manager server 130 may then provide the created list of DRM to the content service server 120 in operation 1522. The content service server 120 may analyze the list of DRM and assign at least one download service server by using the list of DRM in operation 1524. For example, the content service server 120 may assign the first and n^{th} download service servers 140-1 and 140-n. The content service server 120 may request to create and download respective DRM licenses from the first and n^{th} download service servers 140-1 and 140-n in sequence or in parallel in operations 1528 and 1532, respectively. The first and n^{th} download service servers 140-1 and 140-n may each create corresponding DRM licenses in operations 1534 and 1536, respectively. The content service server 120 may also request from the second download service server 140-2 to create, collect, and download the DRM licenses in operation 1542. The second download service server 140-2 may then create corresponding DRM licenses in operation 1544. The first and n^{th} download service servers 140-1 and 140-n may each forward their created DRM licenses to the second download service server 140-2 in operations 1548 and 1552, respectively. Then the second download service server 140-2 may collect the DRM licenses received from the first and n^{th} download service servers 140-1 and 140-n in operation 1554. The second download service server 140-2 may provide DRM information having collected DRM licenses for the end user device 110 in operation 1556. The end user device 110 may then match corresponding DRM information received from the second download service server 140-2 with the content in operation 1558. To do so, the end user device 110 has a function of header addition, according to which the end user device 110 is able to add at least one piece of the corresponding DRM information in the header of the stored content.

As such, the user can reproduce his/her own content not only online but also offline when reproducing the content on any of his/her registered devices without a need to obtain new DRM licenses from a server. Accordingly, free sharing of content can be realized among user devices that support different DRM.

The present inventive concept can be embodied as computer-readable codes on a computer-readable storage medium. The computer-readable storage medium is any data storage device that can store data which can be thereafter read by a computer system. Examples of the computer-readable storage medium include a magnetic storage medium (e.g., a read only memory (ROM), floppy disk, hard disk, etc.) and an optical medium (e.g., a compact disc ROM (CD-ROM), digital versatile disc (DVD), etc.).

While the present inventive concept has been particularly shown and described with reference to exemplary embodiments thereof, it will be understood by those of ordinary skill in the art that various changes in form and details may be made therein without departing from the spirit and scope as defined by the following claims.

What is claimed is:

1. A method of managing content among user devices, the method comprising:
requesting, from a first server, a list of Digital Rights Management (DRM) supported by at least one user device upon receiving a request to download content;
using the list of DRM received from the first server to assign at least one second server supported by the at least one user device; and
communicating with the assigned at least one second server to download, to the end user device, the content with at least one DRM license supported by the at least one user device.

2. The method of claim 1, wherein the first server is a domain manager server that registers a plurality of user devices and that creates the list of DRM supported by the registered user devices.

3. The method of claim 1, wherein the end user device is one of the registered user devices.

4. The method of claim 1, wherein the at least one second server comprises at least one download service server that stores DRM information supported by the registered user devices and downloads content according to a request.

5. The method of claim 2, wherein the first server creates the list of DRM supported by at least one user device by using the registered user devices when requested for the list of DRM.

6. The method of claim 1, wherein downloading the content comprises, requesting and receiving at least one DRM license from the assigned at least one second server; and
requesting to download content from a second server selected from the assigned at least one second server and forwarding the at least one DRM license to the selected second server,
wherein the selected second server uses the at least one DRM license to create a content header and provides the content with the content header to the end user device.

7. The method of claim 6, wherein requesting and receiving at least one DRM license from the assigned at least one second server is performed in sequence or in parallel.

8. The method of claim 1, wherein downloading the content comprises:
requesting to create the at least one DRM license from the assigned at least one second server and forwarding the created at least one DRM license to a selected second server,
wherein the selected second server collects the created at least one DRM license to create a content header and provides the content with the content header for the end user device.

9. The method of claim 1, wherein the at least one DRM license supported by the at least one user device may be added to DRM information of the content header.

10. A method of managing content among user devices that support different Digital Rights Management (DRM), the method comprising:
requesting, from a first server, a list of DRM supported by at least one user device upon receiving a request for DRM information;
using the list of DRM received from the first server to assign at least one second server supported by the at least one user device; and
communicating with the assigned at least one second server to download the DRM information that includes at least one DRM license to the end user device.

11. The method of claim 10, wherein upon receiving the request for the list of DRM, the first server uses registered user devices to create the list of DRM supported by the at least one user device.

12. The method of claim 10, wherein communicating with the assigned at least one second server to download the DRM information that includes at least one DRM license to the end user device comprises requesting to download corresponding DRM licenses to the end user device from the at least one second server.

13. The method of claim 10, wherein communicating with the at least one second server to download the DRM information that includes at least one DRM license to the end user device comprises,
requesting at least one DRM license from the assigned at least one second server, forwarding the at least one DRM license to a selected one of the at least one second server, and requesting from the selected one of the at least one second server to download the at least one DRM license to the end user device,
wherein the selected one of the at least one second server collects the at least one DRM license and downloads DRM information including the collected at least one DRM license to the end user device.

14. The method of claim 10, wherein communicating with the at least one second server to download the DRM information that includes at least one DRM license to the end user device, comprises,
requesting to create at least one DRM license from the assigned at least one second server, and to collect and download the created at least one DRM license to the end user device from a selected one of the at least one second server,
wherein the selected one of the at least one second server collects the at least one DRM license and downloads the DRM information including the collected at least one DRM license to the end user device.

15. The method of claim 10, further comprising:
the end user device matching the DRM information with previously stored content.

16. The method of claim 10, further comprising:
adding information of at least one DRM license supported by the at least one user device in a header field of previously stored content.

17. An apparatus for managing content, the apparatus comprising:
a content purchase handling unit that requests a list of Digital Rights Management (DRM) supported by at least one user device from a domain manager server upon receiving, from an end user device, a request to download content or DRM information;
a server assigning unit that analyzes the list of DRM received from the domain manager server and assigns at least one download service server supported by the at least one user device, upon receiving the request for the list of DRM from the content purchase handling unit; and
a DRM information processing unit that communicates with the assigned at least one download service server to download, to the end user device, the at least one DRM license or content including at least one DRM license.

18. The apparatus of claim 17, wherein the DRM information processing unit requests and receives at least one DRM license from the assigned at least one download service server in sequence or in parallel.

19. A system for managing content, the system comprising:
a domain manager server that registers at least one user device and creates a list of Digital Rights Management (DRM) supported by at least one registered user device, in response to a request for the list; and
a content service server that requests and receives, from the domain manager server, the list of DRM supported by the at least one registered device, uses the received list of DRM to assign at least one download service server supported by the at least one registered user device, and communicates with the assigned at least one download service server to download, to the end user device, content including at least one DRM license supported by at least one user device,
wherein the at least one download service server stores at least one DRM license supported by the registered at least one user device and provides content with the at least one DRM license for the end user device when requested by the content service server.

20. The method of claim 19, wherein the download service server comprises:
a DRM information creating unit that creates the at least one DRM license, or collects DRM licenses from other download service servers to create a content header, when requested to download content with DRM by the content service server, and
a DRM information providing unit that provides the at least one DRM license or the content header created by the DRM information creating unit to the end user device.

21. The method of claim 19, wherein the download service server comprises a DRM license server that provides information of DRM licenses supported by the at least one registered user device.

22. A computer-readable storage medium having a program stored thereon for executing a method comprising:
requesting, from a first server, a list of Digital Rights Management (DRM) supported by at least one user device upon receiving a request to download content;
using the list of DRM received from the first server to assign at least one second server supported by the at least one user device; and
communicating with the assigned at least one second server to download, to the end user device, the content with at least one DRM license supported by the at least one user device.

23. A method for managing content having digital rights management (DRM) licenses distributed across a plurality of user devices and serviced by a plurality of download service servers, the method comprising:
receiving, from an end user device, a request to use content;
sending, to a domain manager server, which has pre-registered the plurality of user devices and maintains digital rights management (DRM) information for each of the user devices, a request for a list of DRM information supported by one or more of the user devices;
receiving the list of supported DRM information;
assigning, using the received list of supported DRM information, one or more of the download service servers to serve the content; and
commanding the assigned one or more download service servers to serve the content with one or more DRM licenses supported by the end user device, to the end user device.

24. The method of claim 23, wherein the plurality of user devices support different DRM.

25. The method of claim 24, wherein the plurality of user devices comprises the end user device.
